(19) United States
(12) Patent Application Publication
(10) Pub. No.: US 2008/0145575 A1
(43) Pub. Date: Jun. 19, 2008

(54) Composite sheet of printable individual media cards

(76) Inventor: Marie C. Forte, Stamford, CT (US)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 11/985,644

(22) Filed: Nov. 15, 2007

Related U.S. Application Data
(60) Provisional application No. 60/859,466, filed on Nov. 15, 2006.

(51) Int. Cl. B41M 5/00

(52) U.S. Cl. 428/32.18; 428/32.1

(57) ABSTRACT

A composite sheet of individual rectangular media cards for ink jet and laser printers includes a rectangular card stock sheet, and an adhesive releasably adhering the card stock sheet to a liner. Widthwise and lengthwise media card definition cuts extend through the card stock sheet but not the linear to define the media cards. Spaced-apart liner flex cuts are formed aligned with at least one lengthwise media definition cut and spaced from adjacent corners of adjacent media cards.

### RELATED APPLICATIONS

This application claims priority from the U.S. Provisional application Ser. No. 60/859,466 filed Nov. 15, 2006.

### FIELD OF THE INVENTION

The invention herein relates to a composite sheet of individual media cards supported on a liner and easily separable therefrom after printing.

### BACKGROUND OF THE INVENTION

With the current availability of high quality desktop printers and sophisticated word processing and desktop publishing software, it is both desirable and possible to print quality graphic products without requiring print shop or other professional printing services. One obstacle to producing high quality graphics products on desktop printers is the print media itself, particularly when printing small individual media products, such as business cards.

Quality card stock is readily available to accept black and white and/or color printing. However, the desktop printers only accept card stock in relatively large sizes, e.g. standard 8½″×11½″ paper, A4 size paper, and to a lesser extent, envelopes. Even though the printers will accept and pass media stock of envelope size or smaller, it is not possible to feed a standard 2″×3½″ business card media stock, or to achieve registration of printing and graphics on such a media card if the printer can be coaxed into accepting it for printing.

To solve the foregoing products, individual media cards, such as business cards, have been formed as part of a composite sheet. The composite sheet is generally a laminate or plurality of layers, consisting of card stock and a backer, sometimes also referred to as a liner. The card stock is separated into individual media and supported on the liner during printing. After printing, individual media cards are separated from the others, and often from the liner as well. To this end, the liner may have a releasable adhesive holding the individual media cards to it.

Further technical problems reside in how to separate individual media cards held on a liner. One method is to form a complete cut about the entire periphery of the media, which provides a sharp clean edge for the individual media, but in using this method the media must be sufficiently adhered to the liner so that it doesn't separate from the liner during the curved feed path found in most desktop printers. On the other hand, the media must not be adhered too well to the liner, so that the media may be removed from the liner.

Another method of separating the individual media is to form perforated separation lines about the perimeter thereof. Thus, the card stock is not fully separated until after printing, which resolves many of the technical problems in providing individual media cards completely cut apart and adhered to a liner. However, the perforated cuts leave a less than desirable edge.

Therefore, to date, there have been no fully satisfactory composite sheets for printing individual media, and improvement in the art should be well-received.

### SUMMARY OF THE INVENTION

It is a principal object of the invention herein to provide an improved composite sheet of individual media cards.

It is another object of the invention herein to provide an improved composite sheet of individual media cards sized for use as business cards.

It is another object of the invention herein to maintain the integrity of a composite sheet of individual media cards during and after printing, yet provide for easy separation of the individual media card after printing.

It is also an object of the invention herein to reduce separation and curl that may be imparted to the individual media by printing in desktop printers.

In carrying out the foregoing objects of the invention, there is provided a composite sheet of plural individual rectangular media cards for printing by inkjet and laser printers. The composite sheet is made of a rectangular card stock sheet having a length and a width, the length establishing a length-wise direction for passing the composite sheet through a printer. The card stock sheet has a front surface for printing and a back surface. A liner sheet is juxtaposed the back surface of the card stock sheet and has a layer of adhesive applied thereto for releasably adhering the card stock sheet to the liner sheet. A plurality of width-wise and a plurality of length-wise media card definition cuts extend through the card stock sheet, but not through the liner sheet, to define a plurality of individual rectangular media cards releasably adhered to the liner sheet. The width-wise and length-wise media card definition cuts form flanking edges of adjacent individual media cards and intersect to form corners of adjacent individual media cards, the corners being connectably supported by the liner sheet. A plurality of spaced-apart liner flex cuts are formed aligned with the length-wise media card definition cuts and extend through the liner sheet, each liner flex cut positioned between and spaced from corners of adjacent individual media cards wherein at least some of the flanking edges of adjacent individual media cards are unconnectedly supported by the liner sheet.

According to further aspects of the invention, the card stock may be pulp, cotton or a liner paper and may be in the range of 8 mils to 11 mils thick, and may be 10 mils thick. The liner sheet may be pulp or other suitable paper and may be in the range of 4 mils thick, with a weight of 70 g/m² to 6½ mils thick with a weight of 140 g/m². The adhesive is a low tach, repositionable adhesive. The adhesive may be coated directly onto the liner without coating the liner with other coating materials.

According to further aspects, two columns of the media cards are formed on one composite sheet, defined by a central and two side length-wise media definition cuts, such that the composite sheet has card stock margins having liner releasably adhered thereto. The liner flex cuts may be provided on the central length-wise media definition cut, and the liner flex cuts may be provided on the side length-wise media definition cuts, and the liner flex cuts may be provided on all of the of the center and side length-wise media definition cuts.

According to another aspect of the invention, the line flex cuts may have a length of one-half to two-thirds of the flanking edges of adjacent media cards extending between adjacent corners of adjacent media cards.

Other and more specific objects and features of the invention herein will, in part, be recognized by those skilled in the art and will, in part, appear in the following Detailed Description and the Claims, taken together with the Drawings.

### BRIEF DESCRIPTION OF DRAWINGS

FIG. 1 is a front plan view of a composite sheet of media cards according to the invention herein;

FIG. 2 is a back view of the composite sheet of individual media cards of FIG. 1;

FIG. 3 is a sectional view of the composite sheet of FIG. 1, taken along the lines 3-3 of FIG. 1;

FIG. 4 is a sectional view of the composite sheet of media cards of FIG. 1, taken along the lines 4-4 of FIG. 1;

FIG. 5 is a sectional view of the composite sheet of media cards of FIG. 1, taken along the lines 5-5 of FIG. 2; and

FIG. 6 is a sectional view of the composite sheet of media cards of FIG. 1, taken along the lines 6-6 of FIG. 2.

The same reference numerals refer to the same elements throughout the various figures.

### DETAILED DESCRIPTION

A composite sheet 10 of plural individual media cards 20-29 is illustrated in the various figures, and generally comprises a card stock sheet 30, a liner sheet 32 and an adhesive layer 34 releasably securing the card stock sheet 30 and the plurality of individual media cards 20-29 to the liner sheet.

The plurality of individual media cards are rectangular portions of the card stock sheet 30, shown in a size suitable for printing as business cards, formed by dividing the card stock sheet 30 as more fully discussed below.

The card stock sheet 30 is a pulp paper having a thickness of about 10 mils and a weight of about 220 g/m². The card stock sheet may also be linen or cotton based paper, and may have a thickness range of from about 8 mils to about 11 mils. It is coated with a polymer on both sides, but may be coated on one side or uncoated. The card stock sheet 30 is suitable for use in constructing a composite sheet 10 that is accepted by most desktop inkjet and laser printers. The card stock sheet has a front surface 36 for printing text and graphic images thereon. The surface 36 may be coated to enhance the acceptance of inkjet inks and/or laser printer toner, to enhance brightness and to otherwise optimize printing, as is well known in the art.

The liner sheet 32 is preferably a pulp paper having a thickness in the range of 4 mils and weight of 70 g/m² to 6½ mils and weight of 140 g/m², i.e. substantially less dense than the card stock sheet 30. The liner sheet is uncoated, although it may be coated, if desired, as is well known in the art.

The card stock sheet 30 and more particularly a back surface 38 thereof is releasably adhered to the liner sheet 32 by an adhesive 34. The adhesive is a low tack repositionable type and PROTECT 8748 low tack polymer adhesive is suitable for the adhesive layer of 34. The adhesive may be applied to the liner 32 at a rate of 3-7 g/m². The adhesive adheres well to the liner sheet such that the liner sheet is not releasable from the adhesive. If a coated liner sheet is utilized, care is taken to select the coating to cooperate with the adhesive such that the adhesive remains adhered to the liner sheet as the plurality of individual media cards 20-29 are removed therefrom.

The card stock sheet 30 and the liner sheet 32 are co-extensive and share the same perimeter edges and dimensions. These include a leading edge 40, a trailing edge 42, and side edges 44 and 46. The leading edge 40 and the trailing edge 42 are structurally the same, and are designated as “leading” and “trailing” because of their orientation in the various figures and either of the edges 40, 42 may be used as the first edge to enter a printer. However, the composite sheet 10 is intended for use in the portrait orientation for reasons more fully discussed below, and it is not recommended that the side edges 40, 46 be presented to a printer that has substantial curves or sharp turns in its paper path. The composite sheet 10 may be 8½″ in the width-wise direction, i.e. between the side edges 44, 46, and may have a length of 11½″ between the leading and trailing edges 40, 42. This dimension is chosen because it is relatively standard, and composite sheet 10 may be provided in other sizes acceptable by a printer and also sufficiently large to provide a plurality of individual rectangular media cards thereon.

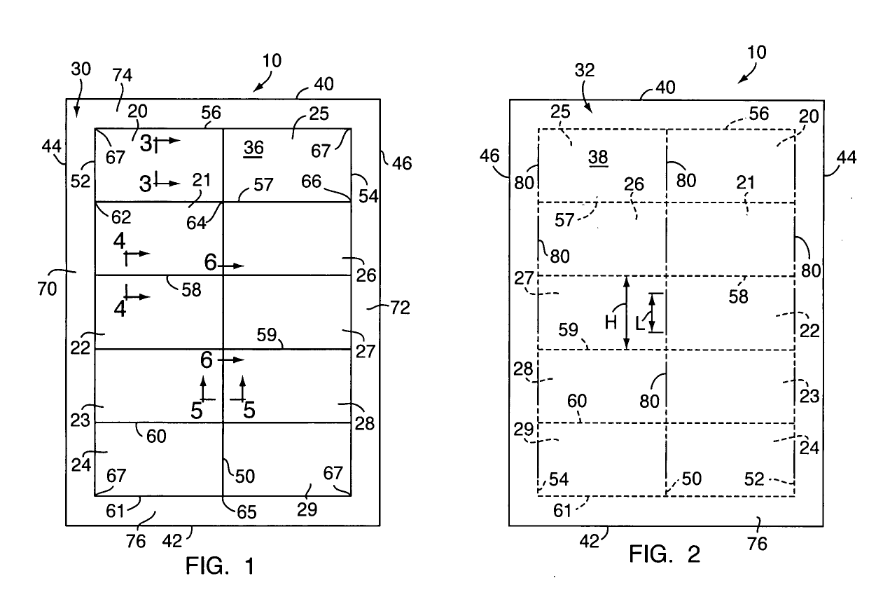

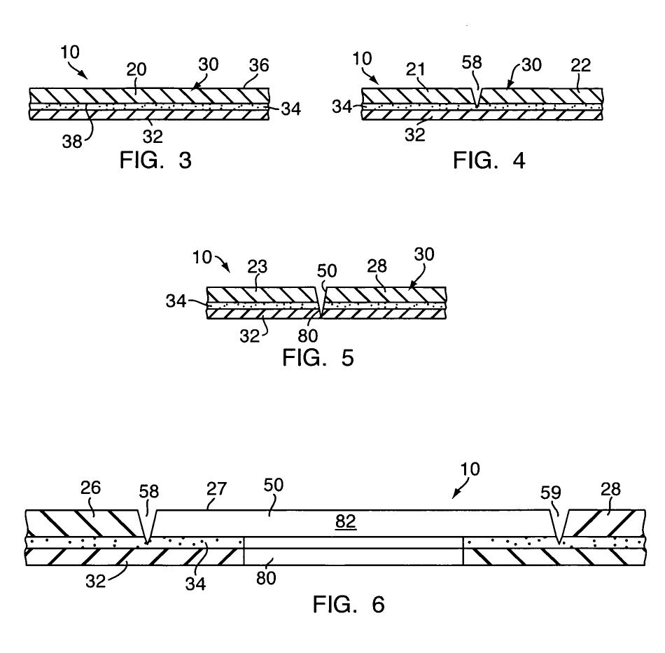

The plurality of individual rectangular media cards 20-29 are formed from the card stock sheet 30 by media card definition cuts. There are three length-wise media card definition cuts; namely, a central length-wise media card definition cut 50 and two side length-wise media definition cuts 52 and 54. There are six width-wise media card definition cuts 56-61. The width-wise media definition cuts 56-61 intersect and extend between the side length-wise media definition cuts 52 and 54, and also intersect the central length-wise media definition cut 50. With reference to FIG. 1, this is illustrated where width-wise media definition cut 57 intersects the side length-wise media definition cut 52 at 62, intersects the central length-wise media definition cut 50 at 64, and intersects the side length-wise media definition cut 54 at 66. This divides the sheet 30 into ten individual rectangular media cards 20-29, each having a dimension of 2″×3½″ such that they are suitable for printing as business cards, and leaves a peripheral margin with sides 70 and 72, and ends 74 and 76.

With reference to FIG. 4, the width-wise media definition cut 58 is illustrated, and can be seen to extend entirely through the card stock sheet 30, but not through the liner sheet 32. In the embodiment shown, the media definition cut 58 extends into the adhesive 34, which is desirable to accommodate any manufacturing tolerances in the depth of the cut to ensure that the cut extends through the card stock sheet 30. The media definition cuts may or may not extend part way into the liner sheet 30, and this is also in part a matter of manufacturing tolerances. However, it is contemplated that the cut does not extend through the liner sheet 30, except as specifically intended and further discussed below.

Therefore, in the central area of the composite sheet 10, the adjacent individual rectangular media cards have juxtaposed or flanking edges separated by media card definition cuts, and the individual media cards also have juxtaposed flanking edges with the sides 70, 72 and ends 74, 76 of the peripheral margin also separated by media card definition cuts. Where the media definition cuts intersect, adjacent media cards also have adjacent corners. For example, media cards 20, 21, 25 and 26 have four adjacent corners at the intersection 64 of width-wise media definition cut 57 and length-wise media definition cut 50, and media cards 24 and 29 have adjacent corners at the intersection 65 of width-wise media definition cut 61 and central length-wise media definition cut 50. The media cards 20, 24, 25 and 29 deployed toward the corners of the composite sheet 10 are defined by intersecting media definition cuts, e.g. side length-wise media definition cut 52 and width-wise media definition cut 36, intersect at 66 and are considered to have the equivalent of adjacent corners because of their proximity to the juxtaposed and flanking portions of the peripheral margin.

With reference to FIGS. 2, 5 and 6, the composite sheet 30 is further provided with a plurality of spaced-apart liner flex cuts 80. The liner flex cuts are formed aligned with the length-wise media card definition cuts 50, 52, 54 and are positioned between and spaced from the adjacent corners of adjacent individual media cards defined by the width-wise media definition cuts 56-61. As noted above, the width-wise media definition cuts 50 and 56 have ends 74, 76 of the margin adjacent thereto, and these end margin portions are considered equivalent to corners of an adjacent media cards for the purposes of providing juxtaposed and flanking adjacent card stock.

The liner flex cuts are particularly well illustrated in FIG. 6, where the media card 21 is separated from media cards 20 and 23 by width-wise media definition cuts 57 and 58 and is separated from media card 26 by the central media definition cut 50, which appears along the edge 82 of media card 21. The liner flex cut 80 extends through the liner sheet 32, and is positioned between the width-wise media definition cuts 57 and 58, and spaced from the corners of the media card 21. The length L of the liner flex cut 80 is preferably about one-half to two-thirds of the height H of media card 21 and is deployed approximately mid-way between the corners of media card 21. The liner flex cuts may also be of lesser length, and may be a line of perforations extending to near adjacent corners of adjacent media cards.

This arrangement results in the adjacent corners of the media cards 21-29, including those corners adjacent marginal edges, being connectedly supported on the liner sheet 32. As the composite sheet 30 is passed through a printer, the connectedly supported corners tend not to separate from the liner sheet 32 such that they would cause paper jams, and the structure of the composite sheet at the corners remains of the individual media cards 20-29 from the liner sheet 32, with the stiffness of the card stock providing “lift off” at the corners so that no picking is required to separate an individual media card from the liner sheet.

By forming the liner flex cuts 80 along the length-wise media definition cuts 50, 52, 54, the composite sheet 10 is stable and maintains its dimensions as it is handled by a printer, and the composite sheet 10 resists jams when passing through a printers.

Accordingly, a composite sheet of individual rectangular media cards has been described which admirably achieves the objects of the invention herein. It will be appreciated that the foregoing detailed description is directed toward a particular preferred embodiment of the invention, and that various changes may be made by those skilled in the art without departing from the spirit and scope of the invention, which is limited only by the following claims.

1. A composite sheet of plural individual rectangular media cards for printing by inkjet and laser printers comprising:
A) a rectangular card stock sheet having a length and a width, the length establishing a length-wise direction for passing the composite sheet through a printer, and having a front surface for printing and a back surface;
B) a liner juxtaposed the back surface of the card stock sheet and having a layer of adhesive applied thereto for releasably adhering the card stock sheet to the liner sheet;
C) a plurality of width-wise and a plurality of length-wise media card definition cuts extending through the card stock sheet but not through the liner sheet to define a plurality of individual rectangular media cards releasably adhered to the liner sheet, the width-wise and length-wise media card definition cuts forming juxtaposed flanking edges of adjacent individual media cards and intersecting to form corners of adjacent individual media cards, the corners being connectedly supported by the liner sheet; and
D) a plurality of spaced-apart liner flex cuts formed aligned with at least one of the length-wise media card definition cuts and extending through the liner sheet, the liner flex cuts positioned between and spaced from corners of adjacent individual media cards, where at least some of the juxtaposed flanking edges of adjacent media cards along a length-wise media card definition cut are unconnectedly supported by the liner sheet.

2. A composite sheet as defined in claim 1 wherein the card stock has a thickness in the range of 8 mils to 11 mils.

3. A card stock as defined in claim 2 wherein the card stock has thickness of about 10 mils and a weight of about 220 g/m².

4. A composite sheet as defined in claim 1 wherein the liner sheet is paper having a thickness in the range of 4 mils with a weight of about 70 g/m² to about 6½ mils with a weight of about 140 g/m²

5. A composite sheet as defined in claim 1 wherein the adhesive is a low tack repositionable adhesive.

6. A composite sheet as defined in claim 5 wherein the adhesive is coated onto an uncoated surface of the liner sheet.

7. A composite sheet as defined in claim 1 wherein the plurality of individual rectangular media cards comprise two rows of media cards defined by a central length-wise media card definition cut and two side length-wise media card definition cuts.

8. A composite sheet as defined in claim 7 wherein the card stock sheet has a peripheral margin including side and end portions together surrounding the plurality of individual rectangular media cards.

9. A composite sheet as defined in claim 8 wherein spaced-apart liner flex cuts are formed aligned with a central length-wise media definition cut and extending through the liner sheet.

10. A composite sheet as defined in claim 9 wherein spaced-apart liner flex cuts are formed aligned with the side length-wise media definition cuts and extending through the liner sheet.

11. A composite sheet as defined in claim 10 wherein the liner flex cuts have a length of between one-half to two-thirds of the height of the individual rectangular media cards adjacent thereto.

12. A composite sheet as defined in claim 11 wherein the line flex cuts are positioned centrally between the corners of the individual media cards.

13. A composite sheet as defined in claim 8 wherein there are six width-wise media card definition cuts extending between the two side length-wise media definition cuts.

14. A composite sheet as defined in claim 1 wherein spaced-apart liner flex cuts are formed aligned with a central length-wise media definition cut and extending through the liner sheet.

15. A composite sheet as defined in claim 1 wherein liner flex cuts are formed along all of the length-wise media definition cuts with at least one liner flex cut formed an edge of each media card.
